(19) United States
(12) Patent Application Publication
(10) Pub. No.: US 2011/0183035 A1
(43) Pub. Date: Jul. 28, 2011

(54) COOKING METHOD USING AN AUTOMATIC PRESSURE DOUBLE BOILER

(76) Inventor: Young Woo KIM, Uiwang-si (KR)

(21) Appl. No.: 13/009,597

(22) Filed: Jan. 19, 2011

(30) Foreign Application Priority Data
Jan. 22, 2010 (KR) 10-2010-0006057

(51) Int. Cl. A23L 1/01; H05B 3/02

(52) U.S. Cl. 426/46; 426/511; 426/243; 219/440

(57) ABSTRACT

A cooking method using an automatic pressure double boiler is provided. The cooking method can prevent steam containing the medicinal or nutritive components in the medicine or health food from leaking out of the cooking pot, and thus keep the medicinal or nutritive effect of the medicine or health food, compared with conventional cooking methods, such as baking with fire, boiling with water, frying with oil, steaming, etc. The cooking method does not allow the boiled water or steam to enter the inner cooking pot, thereby acquiring pure medicinal or nutritive components from the medicine or health food. Since the cooking method heats the medicine or food with the energy of the steam from the boiled water, not direct or conducted heat energy from an electric heater, it cannot burn the medicine or food although it heats it to extract the pure medicinal or nutritive components and condenses them.

### BACKGROUND OF THE INVENTION

1. Field of the Invention

This invention relates to cooking systems, and more particularly, to a method that cooks a variety of food, such as medicine, meals, etc., without the loss of characteristic components contained in the food cooked in an automatic pressure double boiler. This cooking method also easily cooks a variety of health food at home using an automatic pressure double boiler.

2. Description of the Related Art

The term ‘double-boiling’ means a process to heat or warm food in a pot that is placed in boiling water. Korean Standards Association further defines the term as an indirect heating process to cook a substance held in a cooking container and a heater between in which a certain amount of water is placed.

Traditionally, Korean people have manufactured restoratives or heal food via a double boiling method using a cauldron. This traditional method is performed as follows. A certain amount of water is poured in a cauldron in which a plate is placed. A vessel or ceramic pot is placed on the plate. The vessel or ceramic pot holds medicine or food and then is sealed. The cauldron is then covered by a lid. After that, the cauldron is fed a fire with wood, so that the boiling water or steam can heat the vessel or ceramic pot. In that case, the vessel or ceramic emits far infrared rays into the medicine or food, thereby manufacturing or cooking them.

While double-boiling is performed in a cauldron described above, the steam comes out of the cauldron and simultaneously the steam also comes from the vessel or ceramic pot together with the medicinal or food components. This causes a loss in the medicinal effect or nutritive substance from the medicine or food in the vessel or ceramic pot. In addition, the boiled water or steam from the cauldron may enter the vessel or ceramic pot, and this causes difficulty in extracting the pure medicinal or food components from the medicine or food.

In recent years, automatic pressure double boilers have been widely used, so that people can easily cook a variety of medicine and food at home.

However, while conventional automatic pressure double boilers cook medicine or food at home, they cannot prevent the steam which contains the medicinal or food components from spreading, and this smell causes inconveniences neighbors. In addition, conventional double-boilers are so complicated that users find it difficult to operate them to cook medicine or food. Therefore, a new cooking method is required for cooking in an automatic pressure double boiler.

In addition, new automatic pressure double boilers are needed that can cook a variety of medicine or food without allowing any smell to leak, so that odors can be prevented and also the medicinal or nutritive components remain intact. Additionally, new automatic pressure double boilers are needed to improve the mechanical complexity, so that users can easily handle them to cook a variety of medicine or food.

### SUMMARY OF THE INVENTION

The invention has been made in view of the above problems, and provides a cooking system that: can uniformly heat the inner cooking pot with steam in an sealed outer pot; can prevent the medicinal or food components in the inner cooking pot from leaking, so that the medicinal effect or nutrients can remain; and can allow users to easily cook medicine or health food.

In accordance with an exemplary embodiment of the invention, the invention provides a cooking method using an automatic pressure double boiler comprising: depositing a certain amount of a variety of medicine or food in an inner germanium ceramic pot; opening a cover of the automatic pressure double boiler, and pouring a certain amount of water into a lower pot with a heating plate until the water level reaches a certain height in the lower pot; placing the germanium ceramic pot in a heater, and sealing the inside of the automatic pressure double boiler from the outside environment by covering the automatic pressure double boiler from the upper portion with the cover; setting a cooking mode and time by inputting the cooking mode and time according to the medicine or food to be cooked in the automatic pressure double boiler via an input unit, where the set cooking mode and time are displayed on a display unit and output in a voice via a speaker; operating, by a controller, the automatic pressure double boiler when a signal is input to operate the automatic pressure double boiler in the set cooking mode and time displayed on display unit; checking, by the controller, the amount of water in the lower pot according to the input signal; checking, by the controller, whether the cover is tightly sealed; heating, by the heater, the heating plate according to a signal of the controller, and generating, by the heating plate, steam from the lower pot; double-boiling the inner germanium ceramic pot completely and evenly with steam generated from the lower pot; cooking the medicine and food in the inner germanium ceramic pot in the input cooking mode; periodically monitoring, by the controller, the set cooking time, and controlling the heater; outputting, when the set cooking time has elapsed, a text via a display unit and a voice via a speaker, stating that the cooking has completed; controlling, by the controller, the heater, and removing the steam from the lower pot of the automatic pressure double boiler; checking, by the controller, whether the pressure of the remaining steam inside the lower pot of the automatic pressure double boiler is less than a certain value referred to as a safe pressure value; and outputting, by the controller, when the pressure of the remaining steam is less than the safe pressure value, a text via the display unit and a voice via the speaker, stating that the cover may be opened so that the user can remove it from the automatic pressure double boiler.

### BRIEF DESCRIPTION OF THE DRAWINGS

The features and advantages of the invention will become more apparent from the following detailed description in conjunction with the accompanying drawings, in which:

FIG. 1 illustrates a perspective view of an automatic pressure double boiler according to an embodiment of the invention;

FIG. 2 illustrates a cross-sectional view of the automatic pressure double boiler shown in FIG. 1;

FIG. 3 is a flow chart that describes a first embodiment of a cooking method using an automatic pressure double boiler, according to the invention;

FIG. 4 is a flow chart that describes a second embodiment of a cooking method according to the invention;

FIG. 5 is a flow chart that describes a third embodiment of a cooking method according to the invention;

FIG. 6 is a flow chart that describes a fourth embodiment of a cooking method according to the invention;

FIG. 7 is a flow chart that describes a fifth embodiment of a cooking method according to the invention; and

FIG. 8 is a flow chart that describes a sixth embodiment of a cooking method according to the invention.

### BRIEF DESCRIPTION OF SYMBOLS IN THE DRAWINGS

h: heating plate
H: heater
C: controller
K: upper germanium ceramic pot
L: cover
A1: Deposition of substance
A2: Pouring water
A3: Sealing
A4: Setting a cooking mode and time
A5: Operation
A6: Checking the amount of water
A7: Checking the sealed state of the cover L
A8: Generating the steam
A9: Double-boiling the inner pot K
A10: Cooking
A11: Monitoring cooking time
A12: Completing the cooking
A13: Removing the steam
A14: Checking the pressure
A15: Opening the cover L

### DETAILED DESCRIPTION OF EXEMPLARY EMBODIMENTS

Hereinafter, exemplary embodiments of the invention are described in detail with reference to the accompanying drawings. The same reference numbers are used throughout the drawings to refer to the same or similar parts. Detailed descriptions of well-known functions and structures incorporated herein may be omitted to avoid obscuring the subject matter of the invention.

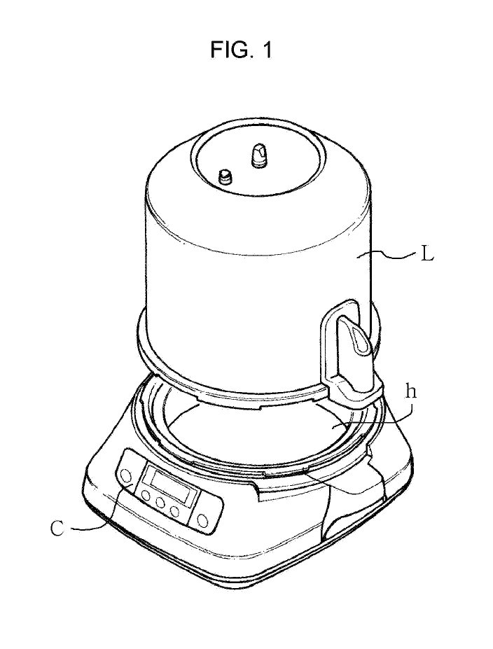

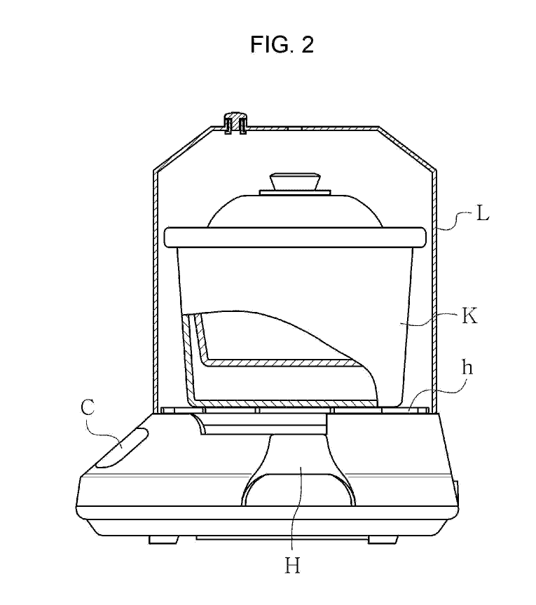

Referring to FIGS. 1 and 2 showing an automatic pressure double boiler according to the invention, exemplary embodiments of a cooking method using the automatic pressure double boiler are described in detail below.

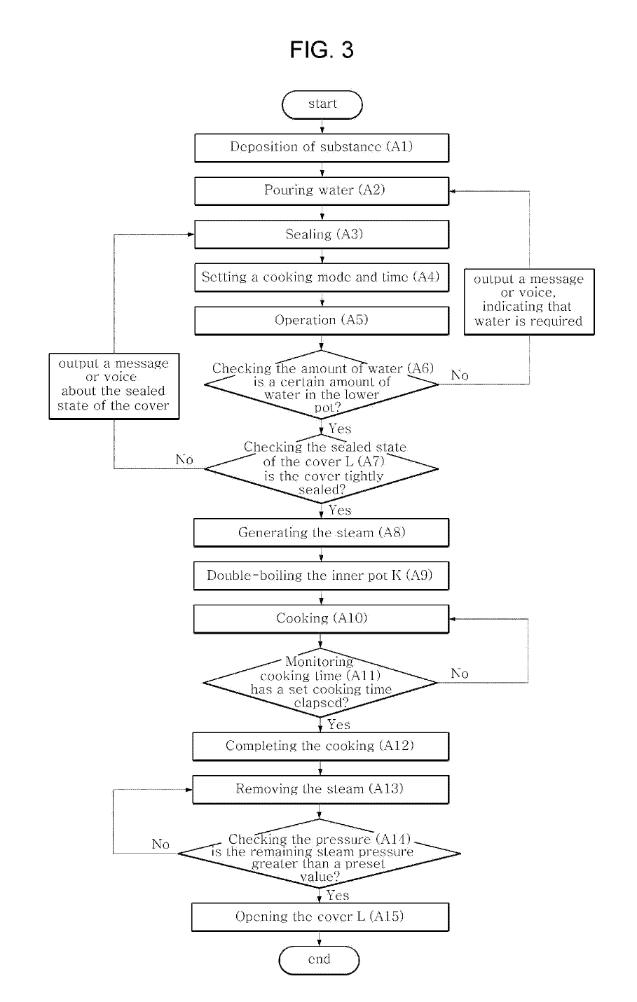

FIG. 3 is a flow chart that describes a first embodiment of a cooking method using an automatic pressure double boiler, according to the invention. Referring to FIG. 3, the first embodiment is performed as follows.

Deposition of Substance (A1)

A certain amount of a variety of medicine or food is deposited in the inner germanium ceramic pot K.

Pouring Water (A2)

A cover L for an automatic pressure double boiler is opened. A certain amount of water is poured into a lower pot with a heating plate h until the water level reaches a certain height in the lower pot.

Sealing (A3)

The inner pot K is placed in the heater H. The cover L covers the automatic pressure double boiler from the upper portion, so that the inside of the automatic pressure double boiler is sealed.

Setting a Cooking Mode and Time (A4)

The cooking mode and time according to the medicine or food to be cooked is set in the automatic pressure double boiler via the input unit. The set cooking mode and time are displayed on the display unit, and also output in a voice via the speaker.

Operation (A5)

When a signal is input to operate the automatic pressure double boiler in the set cooking mode and time displayed on display unit, the controller C operates the automatic pressure double boiler according to the operation signal.

Checking the Amount of Water (A6)

The controller C checks the amount of water in the lower pot with the heating plate h according to the input signal.

When the controller C ascertains that the lower pot has an amount of water less than a preset value or no water, it informs the user that water is required. In that case, the user pours additionally water into the lower pot.

Checking the Sealed State of the Cover L (A7)

The controller C checks whether the cover L is tightly sealed.

When the controller C ascertains that the cover L is not tightly sealed, it then informs the user of the sealed state of the cover L. In that case, the user corrects the posture of the cover L so that it can tightly seal the inside of the automatic pressure double boiler.

Generating the Steam (A8)

When the heater H heats the heating plate h according to a signal of the controller C, the heating plate h boils the water in the lower pot, and generates steam.

Double-Boiling the Inner Pot K (A9)

The steam generated from the lower pot completely and evenly heats the inner germanium ceramic pot K inside the automatic pressure double boiler.

Cooking (A10)

The medicine and food are cooked in the inner germanium ceramic pot K in the input cooking mode.

Monitoring Cooking Time (A11)

The controller C monitors the set cooking time.

The controller C periodically monitors the set cooking time, and then controls the heater H.

Completing the Cooking (A12)

When the controller C ascertains that the set cooking time has elapsed, it outputs a text via the display unit and a voice via the speaker, stating that the cooking has completed.

Removing the Steam (A13)

When the controller C controls the heater H, steam is removed from the lower pot of the automatic pressure double boiler.

Checking the Pressure (A14)

The controller C checks whether the pressure of the remaining steam inside the lower pot of the automatic pressure double boiler is less than a certain value referred to as a safe pressure value.

Opening the Cover L (A15)

When the controller C ascertains that the pressure of the remaining steam is less than the safe pressure value, it outputs a text via the display unit and a voice via the speaker, stating that the cover L may be opened so that the user can remove it from the automatic pressure double boiler.

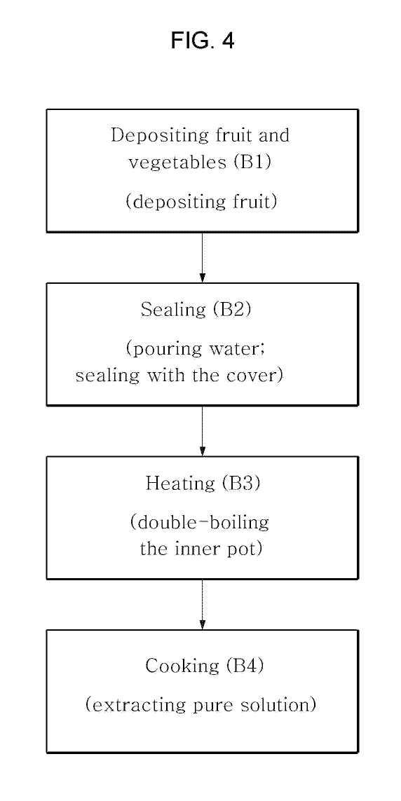

FIG. 4 is a flow chart that describes a second embodiment of a cooking method according to the invention. Referring to FIG. 4, the second embodiment is performed as follows.

Depositing Fruit and Vegetables (B1)

Fruit and vegetables, such as onions, mature pumpkins, pears, apples, apricots, tomatoes, strawberries, grapes, etc., are deposited in the inner germanium ceramic pot K.

Sealing (B2)

A certain amount of water is poured into a lower pot with a heating plate h until the water level reaches a certain height in the lower pot. The cover L covers the lower pot of the automatic pressure double boiler from the upper portion, so that the inside of the automatic pressure double boiler is sealed from the outside environment.

Heating (B3)

The automatic pressure double boiler is operated so that the heater H heats the heating plate h according to a signal of the controller C, and the steam generated from the lower pot with the heating plate h completely and evenly heats the inner pot K.

Cooking (B4)

Fruit and vegetables are heated by far infrared rays emitted from the inner germanium ceramic pot K at 100˜120′C for 4 hours 30 minutes, thereby extracting the condensed undiluted solution of the deposited fruit and vegetables.

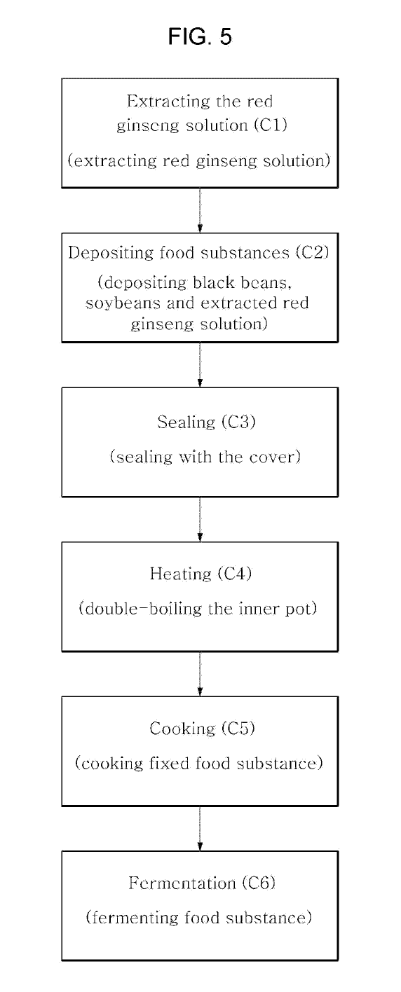

FIG. 5 is a flow chart that describes a third embodiment of a cooking method according to the invention. Referring to FIG. 5, the third embodiment is performed as follows.

Extracting the Red Ginseng Solution (C1)

Raw ginseng and dried ginseng are steamed and ripened in the inner germanium ceramic pot K at 100˜120° C. for about 7 hours; red ginseng 30˜40% and water 60˜70% are deposited in the inner germanium ceramic pot K; and the inner pot K is heated at 100˜120° C. for about 6 hours 30 minutes, thereby extracting the red ginseng solution.

Depositing Food Substances (C2)

300˜400 g of black beans and soybeans are deposited in the inner germanium ceramic pot K, and then 600˜700 g of the extracted red ginseng solution is also deposited therein.

Sealing (C3)

A certain amount of water is poured in a lower pot with a heating plate h until the water level reaches a certain height in the lower pot. The cover L covers the lower pot of the automatic pressure double boiler from the upper portion, so that the inside of the automatic pressure double boiler is sealed from the outside environment.

Heating (C4)

The automatic pressure double boiler is operated so that the heater H heats the heating plate h according to a signal of the controller C, and the steam generated from the lower pot with the heating plate h completely and evenly heats the inner pot K.

Cooking (C5)

The mixed substance in the inner germanium ceramic pot K is boiled at 100˜120° C. for 3 hours.

Fermentation (C6)

The boiled food substance is taken out of the inner germanium ceramic pot K, and poured into an additional pot. The food substance is fermented in the additional pot at about 45° C. for 21 hours, and this allows bacillus to be cultivated therein, thereby manufacturing the fermented bean-paste with red ginseng.

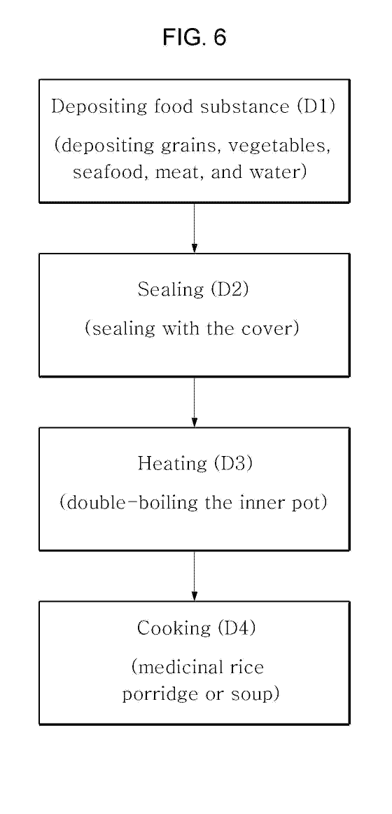

FIG. 6 is a flow chart that describes a fourth embodiment of a cooking method according to the invention. Referring to FIG. 6, the fourth embodiment is performed as follows.

Deposition of Substance (D1)

50˜150 g of rice, 200 g of grains, vegetables, seafood and meat, and 850˜950 g of water are deposited in the inner germanium ceramic pot K.

Sealing (D2)

A certain amount of water is poured into a lower pot with a heating plate h until the water level reaches a certain height in the lower pot. The cover L covers the lower pot of the automatic pressure double boiler from the upper portion, so that the inside of the automatic pressure double boiler is sealed from the outside environment.

Heating (D3)

The automatic pressure double boiler is operated so that the heater H heats the heating plate h according to a signal of the controller C, and the steam generated from the lower pot with the heating plate h completely and evenly heats the inner pot K.

Cooking (D4)

The food substance is heated by far infrared rays emitted from the inner germanium ceramic pot K for 2 hours, thereby producing medicinal rice porridge or soup.

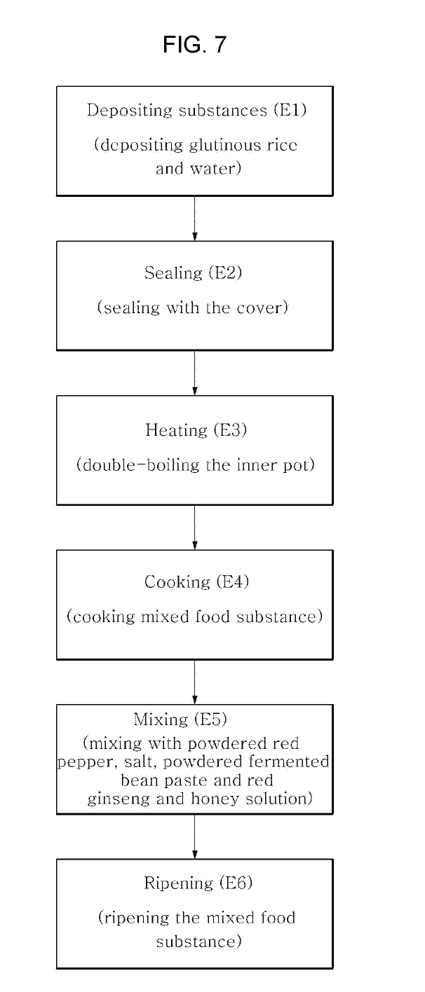

FIG. 7 is a flow chart that describes a fifth embodiment of a cooking method according to the invention. Referring to FIG. 7, the fifth embodiment is performed as follows.

Depositing Substances (E1)

250 g of glutinous rice and 750 g of water are deposited in the inner germanium ceramic pot K.

Sealing (E2)

A certain amount of water is poured into a lower pot with a heating plate h until the water level reaches a certain height in the lower pot. The cover L covers the lower pot of the automatic pressure double boiler from the upper portion, so that the inside of the automatic pressure double boiler is sealed from the outside environment.

Heating (E3)

The automatic pressure double boiler is operated so that the heater H heats the heating plate h according to a signal of the controller C, and the steam generated from the lower pot with the heating plate h completely and evenly heats the inner pot K.

Cooking (E4)

The mixed food substance in the inner germanium ceramic pot K is boiled at 100˜120° C. for 2 hours.

Mixing (E5)

The boiled food substance is taken out of the inner germanium ceramic pot K, and poured into an additional pot. The food substance is mixed with 300 g of powdered red pepper, 100 g of salt, 300 g of powdered fermented bean paste and 300 cc of red ginseng and honey solution.

Ripening (E6)

The mixed food substance is kept and ripened in cold storage for about one week, thereby producing thick soy paste with red peppers, red ginseng and fermented bean-paste.

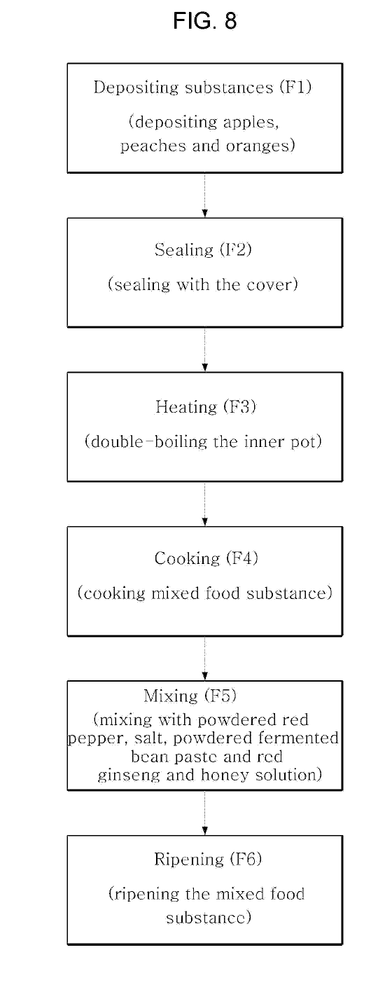

FIG. 8 is a flow chart that describes a sixth embodiment of a cooking method according to the invention. Referring to FIG. 8, the sixth embodiment is performed as follows.

Depositing Substances (F1) 600 g of apples, peaches and oranges are deposited in the inner germanium ceramic pot K.

Sealing (F2)

A certain amount of water is poured into a lower pot with a heating plate h until the water level reaches a certain height in the lower pot. The cover L covers the lower pot of the automatic pressure double boiler from the upper portion, so that the inside of the automatic pressure double boiler is sealed from the outside environment.

Heating (F3)

The automatic pressure double boiler is operated so that the heater H heats the heating plate h according to a signal of the controller C, and the steam generated from the lower pot with the heating plate h completely and evenly heats the inner pot K.

Cooking (F4)

The mixed food substance in the inner germanium ceramic pot K is boiled at 100˜120° C. for 2 hours.

Mixing (F5)

The boiled food substance is taken out of the inner germanium ceramic pot K, and poured into an additional pot. The food substance is mixed with 300 g of powdered red pepper, 100 g of salt, 300 g of powdered fermented bean paste and 300 cc of red ginseng and honey solution.

Ripening (F6)

The mixed food substance is kept and ripened in cold storage, thereby producing thick soy paste with red pepper, fruit, red ginseng and fermented bean-paste.

As described above, the cooking system using an automatic pressure double boiler according to the invention can prevent steam containing the medicinal or nutritive components in the medicine or health food from leaking out of the cooking pot, and thus keep the medicinal or nutritive effect of the medicine or health food, compared with conventional cooking methods, such as baking with fire, boiling with water, frying with oil, steaming, etc.

In addition, the cooking system of the invention does not allow the boiled water or steam to enter the inner cooking pot, thereby acquiring pure medicinal or nutritive components from the medicine or health food. Since the cooking system heats the medicine or food with the energy of the steam from the boiled water, not direct or conducted heat energy from an electric heater, it cannot burn the medicine or food although it heats them to extract the pure medicinal or nutritive components and condenses them. The cooking system of this invention can assist users to easily manufacture health food at home.

Although exemplary embodiments of the invention have been described in detail hereinabove, it should be understood that many variations and modifications of the basic inventive concept herein described, which may be apparent to those skilled in the art, will still fall within the spirit and scope of the exemplary embodiments of the invention as defined in the appended claims.

What is claimed is:

1. A cooking method using an automatic pressure double boiler comprising:
depositing (A1) a certain amount of a variety of medicine or food in an inner germanium ceramic pot (K);
opening a cover (L) of the automatic pressure double boiler, and pouring (A2) a certain amount of water into a lower pot with a heating plate (h) until the water level reaches a certain height in the lower pot;
placing the germanium ceramic pot (K) in a heater (H), and sealing (A3) the inside of the automatic pressure double boiler from the outside environment by covering the automatic pressure double boiler from the upper portion with the cover (L);
setting (A4) a cooking mode and time by inputting the cooking mode and time according to the medicine or food to be cooked in the automatic pressure double boiler via an input unit, where the set cooking mode and time are displayed on a display unit and output in a voice via a speaker;
operating (A5), by a controller, the automatic pressure double boiler when a signal is input to operate the automatic pressure double boiler in the set cooking mode and time displayed on display unit;
checking (A6), by the controller, the amount of water in the lower pot according to the input signal;
checking (A7), by the controller, whether the cover (L) is tightly sealed;
heating, by the heater (H), the heating plate (h) according to a signal of the controller, and generating (A8), by the heating plate (h), steam from the lower pot;
double-boiling (A9) the inner germanium ceramic pot (K) completely and evenly with steam generated from the lower pot;
cooking (A10) the medicine and food in the inner germanium ceramic pot (K) in the input cooking mode;
periodically monitoring (A11), by the controller, the set cooking time, and controlling the heater (H)
outputting (A12), when the set cooking time has elapsed, a text via a display unit and a voice via a speaker, stating that the cooking has completed;
controlling, by the controller, the heater (H), and removing (A13) the steam from the lower pot of the automatic pressure double boiler;
checking (A14), by the controller, whether the pressure of the remaining steam inside the lower pot of the automatic pressure double boiler is less than a certain value referred to as a safe pressure value; and
outputting, by the controller, when the pressure of the remaining steam is less than the safe pressure value, a text via the display unit and a voice via the speaker, stating that the cover (L) may be opened so that the user can remove it from the automatic pressure double boiler.

2. A cooking method using an automatic pressure double boiler comprising:
depositing (B1) fruit and vegetables in an inner germanium ceramic pot (K), where the fruit and vegetables include onions, mature pumpkins, pears, apples, apricots, tomatoes, strawberries and grapes;
pouring a certain amount of water into a lower pot with a heating plate (h) until the water level reaches a certain height in the lower pot, and sealing (B2) the inside of the automatic pressure double boiler from the outside environment by covering the lower pot of the automatic pressure double boiler from the upper portion with a cover (L);
heating (B3), by a heater (H), the heating plate (h) according to a signal of the controller, and double-boiling the inner germanium ceramic pot (K) completely and evenly with the steam generated from the lower pot with the heating plate (h); and
cooking (B4) the fruit and vegetables by far infrared rays emitted from the inner germanium ceramic pot (K) at 100˜120° C. for 4 hours 30 minutes, thereby extracting the condensed undiluted solution of the deposited fruit and vegetables.

3. A cooking method using an automatic pressure double boiler comprising:
extracting (C1) a red ginseng solution by steaming and ripening raw ginseng and dried ginseng in an inner germanium ceramic pot (K) at 100˜120° C. for about 7 hours, by depositing red ginseng 30˜40% and water 60˜70% in the inner germanium ceramic pot (K), and by heating them in the germanium ceramic pot (K) at 100˜120′C for about 6 hours 30 minutes;
depositing (C2) 300˜400 g of black beans and soybeans, and 600˜700 g of the extracted red ginseng solution in the germanium ceramic pot (K);
pouring a certain amount of water into a lower pot with a heating plate (h) until the water level reaches a certain height in the lower pot, and sealing (C3) the inside of the automatic pressure double boiler from the outside environment by covering the lower pot of the automatic pressure double boiler from the upper portion with a cover (L);
heating (C4), by a heater (H), the heating plate (h) according to a signal of the controller, and double-boiling the inner germanium ceramic pot (K) completely and evenly with the steam generated from the lower pot with the heating plate (h);
cooking (C5) the mixed substance in the inner germanium ceramic pot (K) by boiling it at 100˜120° C. for 3 hours; and
taking the boiled food substance from the inner germanium ceramic pot (K), pouring it into an additional pot, fermenting (C6) the food substance in the addition pot at about 45° C. for 21 hours, and allowing bacillus to be cultivated therein, thereby producing fermented bean-paste with red ginseng.

4. The method of claim 2, further comprising:
depositing (D1) 50˜150 g of rice, 200 g of grains, vegetables, seafood and meat, and 850˜950 g of water in an inner germanium ceramic pot (K);
pouring a certain amount of water into a lower pot with a heating plate (h) until the water level reaches a certain height in the lower pot, and sealing (D2) the inside of the automatic pressure double boiler from the outside environment by covering the lower pot of the automatic pressure double boiler from the upper portion with a cover (L);
heating (D3), by a heater (H), the heating plate (h) according to a signal of the controller, and double-boiling the inner germanium ceramic pot (K) completely and evenly with the steam generated from the lower pot with the heating plate (h); and
cooking (D4) the food substance by far infrared rays emitted from the inner germanium ceramic pot (K) for 2 hours, thereby producing medicinal rice porridge or soup.

5. The method of claim 3, further comprising:
a cooking method using an automatic pressure double boiler comprising:
depositing (E1) 250 g of glutinous rice and 750 g of water in an inner germanium ceramic pot (K);
pouring a certain amount of water into a lower pot with a heating plate (h) until the water level reaches a certain height in the lower pot, and sealing (E2) the inside of the automatic pressure double boiler from the outside environment by covering the lower pot of the automatic pressure double boiler from the upper portion with a cover (L);
heating (E3), by a heater (H), the heating plate (h) according to a signal of the controller, and double-boiling the inner germanium ceramic pot (K) completely and evenly with steam generated from the lower pot with the heating plate (h);
cooking (E4) the mixed food substance in the inner germanium ceramic pot (K) by boiling it at 100˜120° C. for 2 hours;
taking the boiled food substance from the inner germanium ceramic pot (K), pouring it into an additional pot, mixing (E5) the food substance with 300 g of powdered red pepper, 100 g of salt, 300 g of powdered fermented bean paste and 300 cc of red ginseng and honey solution; and
keeping and ripening (E6) the mixed food substance in cold storage for about one week, thereby producing the thick soy paste with red peppers, red ginseng and fermented bean-paste.

6. The method of claim 3, further comprising:
depositing (F1) 600 g of apples, peaches and oranges in an inner germanium ceramic pot (K);
pouring a certain amount of water into a lower pot with a heating plate (h) until the water level reaches a certain height in the lower pot, and sealing (F2) the inside of the automatic pressure double boiler from the outside environment by covering the lower pot of the automatic pressure double boiler from the upper portion with a cover (L)
heating (F3), by a heater (H), the heating plate (h) according to a signal of the controller, and double-boiling the inner germanium ceramic pot (K) completely and evenly with the steam generated from the lower pot with the heating plate (h);
cooking (F4) the mixed food substance in the inner germanium ceramic pot (K) by boiling it at 100˜120° C. for 2 hours;
taking the boiled food substance from the inner germanium ceramic pot (K), pouring them into an additional pot, mixing (F5) the food substance with 300 g of powdered red pepper, 100 g of salt, 300 g of powdered fermented bean paste and 300 cc of red ginseng and honey solution; and
keeping and ripening (F6) the mixed food substance in cold storage for about one week, thereby producing thick soy pasted with red pepper, fruit, red ginseng and fermented bean-paste.
